(19) United States
(12) Patent Application Publication
(10) Pub. No.: US 2020/0211545 A1
(43) Pub. Date: Jul. 2, 2020

(54) VOICE INTERACTION METHOD, APPARATUS AND DEVICE, AND STORAGE MEDIUM

(71) Applicant: Baidu Online Network Technology (Beijing) Co., Ltd, Beijing (CN)

(72) Inventors: Gang Zhang, Beijing (CN); Kaihua Zhu, Beijing (CN); Cong Gao, Beijing (CN); Dan Wang, Beijing (CN)

(73) Assignee: Baidu Online Network Technology (Beijing) Co., Ltd., Beijing (CN)

(21) Appl. No.: 16/601,631

(22) Filed: Oct. 15, 2019

(30) Foreign Application Priority Data
Jan. 2, 2019 (CN) 201910002548.2

(51) Int. Cl. G10L 15/22; G06F 3/16; G10L 15/26; G10L 15/18; G10L 13/08

(52) U.S. Cl. CPC G10L 15/22; G06F 3/167; G10L 2015/223; G10L 15/1815; G10L 13/08; G10L 15/26

(57) ABSTRACT

A voice interaction method, apparatus and device, and a computer-readable storage medium are provided. The method includes: receiving a voice signal to be detected within a preset time period; performing a voice identification on the voice signal to be detected, to obtain a text to be detected; and performing a first detection on the text to be detected, and providing a response according to the text to be detected in response to determining that the first detection is passed. In the embodiments, the misrecognition rate of a voice signal during a voice interaction is reduced, thereby improving user experience.

### CROSS-REFERENCE TO RELATED APPLICATION

This application claims priority to Chinese patent application No. 201910002548.2, filed on Jan. 2, 2019, which is hereby incorporated by reference in its entirety.

### TECHNICAL FIELD

The present application relates to a field of voice interaction technology, and in particular, to a voice interaction method, apparatus and device, and a storage medium.

### BACKGROUND

Traditional voice interaction apparatuses are performed in a question-and-answer manner. In the case of voice interaction, firstly, a user needs to wake up the apparatus (generally, the user needs to wake up the apparatus by speaking out a preset definite wake-up word), and secondly, a voice instruction is sent, and the apparatus responds to the voice instruction. The way to respond includes voice announcements, screen presentations, and the like. After completing a round of voice interaction, in case that the user wishes to start a next round of voice interaction, he needs to wake up the device and provide a voice instruction again.

In the above manner, for each voice interaction, the user needs to wake up the apparatus first, which results in a poor user experience. Therefore, at present, a voice interaction technology supports multiple interactions after one wake-up. In this technology, the user only needs to wake up an apparatus at the beginning of the first round of voice interaction. After the first round of voice interaction, a timer of the voice interaction apparatus is turned on. In a case where the timer determines that it has not timed out, the user may provide a voice instruction directly without waking up the apparatus again, if he wishes to start a next round of voice interaction. It can be seen that such an interaction is more similar to a conversation between real humans, which can bring a better user experience.

However, the shortcoming of the voice interaction technology which supports multiple interactions after one wake-up is that the interaction apparatus can be woken up through non-instructed vocal interference, thereby resulting in misidentification. For example, after the voice interaction apparatus is woken up, in a case where the timer determines that it has not timed out, the voice interaction apparatus may receive voice signals other than voice instructions, for example, the voices in a conversation between humans, or the voices sent from apparatuses such as a radio or a television. At this time, the voice interaction apparatus may misidentify the voice signal as a voice instruction and respond to the voice signal, thereby causing an erroneous activation of human-computer interaction and affecting the user experience.

### SUMMARY

A voice interaction method and apparatus are provided according to embodiments of the present application, so as to at least solve the above technical problems in the existing technology.

In a first aspect, a voice interaction method is provided according to an embodiment of the present application. The method includes receiving a voice signal to be detected within a preset time period, performing a voice identification on the voice signal to be detected, to obtain a text to be detected, and performing a first detection on the text to be detected, and providing a response according to the text to be detected in response to determining that the first detection is passed.

In an implementation, the providing a response according to the text to be detected in response to determining that the first detection is passed includes: performing a second detection on the text to be detected in response to determining that the first detection is passed, and performing the response according to the text to be detected, in response to determining that the second detection is passed.

In an implementation, the performing a first detection on the text to be detected includes performing a grammar and/or semantic detection on the text to be detected, with a preset first detection model, and the performing a second detection on the text to be detected includes performing a contextual logic relation detection on the text to be detected, with a preset second detection model.

In an implementation, the method further includes establishing the first detection model by training the first detection model by using a plurality of instruction texts and a plurality of non-instruction texts, wherein the plurality of instruction texts are texts associated with voice instructions, and the plurality of non-instruction texts are texts associated with voice signals other than voice instructions.

In an implementation, the performing a first detection on the text to be detected includes: inputting the text to be detected into the first detection model, and predicting that the text to be detected is an instruction text with the first detection model, and determining that the first detection is passed; or predicting that the text to be detected is a non-instruction text with the first detection model, and determining that the first detection is not passed.

In an implementation, the method further includes establishing the second detection model by training the second detection model by using a plurality of sets of voice interactive texts and a plurality of sets of non-voice interactive texts, wherein each set of voice interactive texts includes texts associated with voice instructions in at least two rounds of voice interactions and responses to the texts, and a contextual logic relation exists between the at least two rounds of voice interactions, and each set of the non-voice interactive texts includes texts associated with at least two voice instructions between which no contextual logic relation exists.

In an implementation, the performing a second detection on the text to be detected includes: inputting the text to be detected, a historical instruction text associated with a historical voice instruction of the text to be detected and a historical response to the historical instruction text into the second detection model, and predicting that the text to be detected has a contextual logic relation with the historical instruction text and the historical response with the second detection model, and determining that the second detection is passed; or predicting that the text to be detected has no contextual logic relation with the historical instruction text and the historical response with the second detection model, and determining that the second detection is not passed.

In a second aspect, a voice interaction apparatus is provided according to an embodiment of the present application. The apparatus includes: a receiving module configured to receive a voice signal to be detected within a preset time period, an identification module configured to perform a voice identification on the voice signal to be detected, to obtain a text to be detected, and a first detection module configured to perform a first detection on the text to be detected, and provide a response according to the text to be detected in response to determining that the first detection is passed.

In an implementation, the apparatus further includes a second detection module configured to perform a second detection on the text to be detected in response to determining that the first detection is passed, and a response module configured to perform the response according to the text to be detected, in response to determining that the second detection is passed.

In an implementation, the first detection module is further configured to perform a grammar and/or semantic detection on the text to be detected, with a preset first detection model, and the second detection module is further configured to perform a contextual logic relation detection on the text to be detected, with a preset second detection model.

In an implementation, the first detection model is established by: training the first detection model by using a plurality of instruction texts and a plurality of non-instruction texts, wherein the plurality of instruction texts are texts associated with voice instructions, and the plurality of non-instruction texts are texts associated with voice signals other than voice instructions.

In an implementation, the first detection module is further configured to input the text to be detected into the first detection model, and predict that the text to be detected is an instruction text with the first detection model, and determine that the first detection is passed; or predict that the text to be detected is a non-instruction text with the first detection model, and determine that the first detection is not passed.

In an implementation, the second detection model is established by: training the second detection model by using a plurality of sets of voice interactive texts and a plurality of sets of non-voice interactive texts, wherein each set of voice interactive texts includes texts associated with voice instructions in at least two rounds of voice interactions and responses to the texts, and a contextual logic relation exists between the at least two rounds of voice interactions, and each set of the non-voice interactive texts includes texts associated with at least two voice instructions between which no contextual logic relation exists.

In an implementation, the second detection module is further configured to input the text to be detected, a historical instruction text associated with a historical voice instruction of the text to be detected and a historical response to the historical instruction text into the second detection model, and predict that the text to be detected has a contextual logic relation with the historical instruction text and the historical response with the second detection model, and determine that the second detection is passed; or predict that the text to be detected has no contextual logic relation with the historical instruction text and the historical response with the second detection model, and determine that the second detection is not passed.

In a third aspect, a voice interaction device is provided according to an embodiment of the present application. The functions of the device may be implemented by using hardware or by corresponding software executed by hardware. The hardware or software includes one or more modules corresponding to the functions described above.

In a possible embodiment, the device structurally includes a processor and a memory, wherein the memory is configured to store a program which supports the device in executing the above voice interaction method. The processor is configured to execute the program stored in the memory. The device may further include a communication interface through which the device communicates with other devices or communication networks.

In a fourth aspect, a computer-readable storage medium for storing computer software instructions used for a voice interaction device is provided. The computer readable storage medium may include programs involved in executing of the voice interaction method described above.

One of the above technical solutions has the following advantages or beneficial effects: in the voice interaction method according to an embodiment of the present application, after a voice interaction apparatus is waken up, it is determined whether a time period of waiting for a voice signal input is larger than a preset time period. In a case where the time period of waiting for a voice signal input is larger than the preset time period, it is determined not to receive any voice signals. In a case where the time period of waiting for a voice signal input is not larger than the preset time period, it is determined to receive voice signals to be detected, and to perform a voice identification on the voice signal to be detected, in order to obtain a text to be detected. Then, subsequent processes for the text to be detected can be performed. In this way, the misrecognition rate of a voice signal during a voice interaction is reduced, thereby improving user experience.

The above summary is provided only for illustration and is not intended to be limiting in any way. In addition to the illustrative aspects, embodiments, and features described above, further aspects, embodiments, and features of the present application will be readily understood from the following detailed description with reference to the accompanying drawings.

### BRIEF DESCRIPTION OF THE DRAWINGS

In the drawings, unless otherwise specified, identical or similar parts or elements are denoted by identical reference numerals throughout the drawings. The drawings are not necessarily drawn to scale. It should be understood these drawings merely illustrate some embodiments of the present application and should not be construed as limiting the scope of the present application.

FIG. 1 is a flowchart showing a voice interaction method according to an embodiment of the present application;

FIG. 2 is a flowchart showing a voice interaction method according to another embodiment of the present application;

FIG. 3 is a flowchart showing a voice interaction process according to an embodiment of the present application;

FIG. 4 is a schematic structural diagram showing a voice interaction apparatus according to an embodiment of the present application;

FIG. 5 is a schematic structural diagram showing a voice interaction apparatus according to another embodiment of the present application; and

FIG. 6 is a schematic structural diagram showing a voice interaction device according to an embodiment of the present application.

### DETAILED DESCRIPTION OF THE EMBODIMENTS

Hereafter, only certain exemplary embodiments are briefly described. As can be appreciated by those skilled in the art, the described embodiments may be modified in different ways, without departing from the spirit or scope of the present application. Accordingly, the drawings and the description should be considered as illustrative in nature instead of being restrictive.

A voice interaction method and apparatus are provided according to embodiments of the present application. The technical solutions are described below in detail by means of the following embodiments.

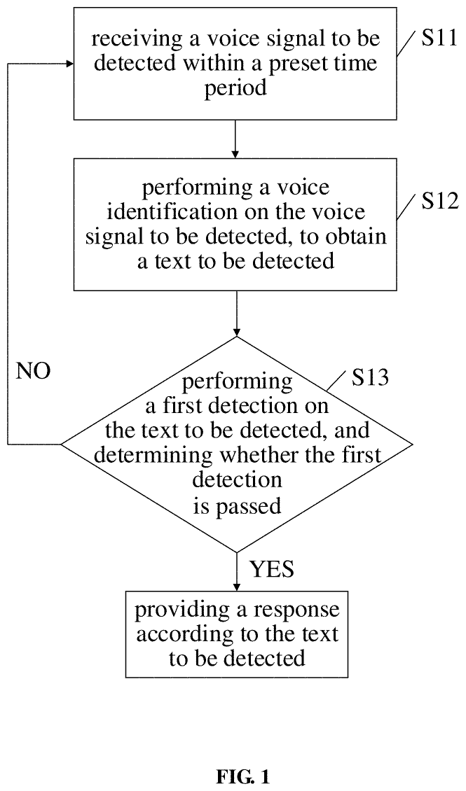

FIG. 1 is a flowchart showing a voice interaction method according to an embodiment of the present application. The method includes: receiving a voice signal to be detected within a preset time period at S11, performing a voice identification on the voice signal to be detected, to obtain a text to be detected at S12, and performing a first detection on the text to be detected, providing a response according to the text to be detected in response to determining that the first detection is passed, or returning to S11 in response to determining that the first detection is not passed at S13.

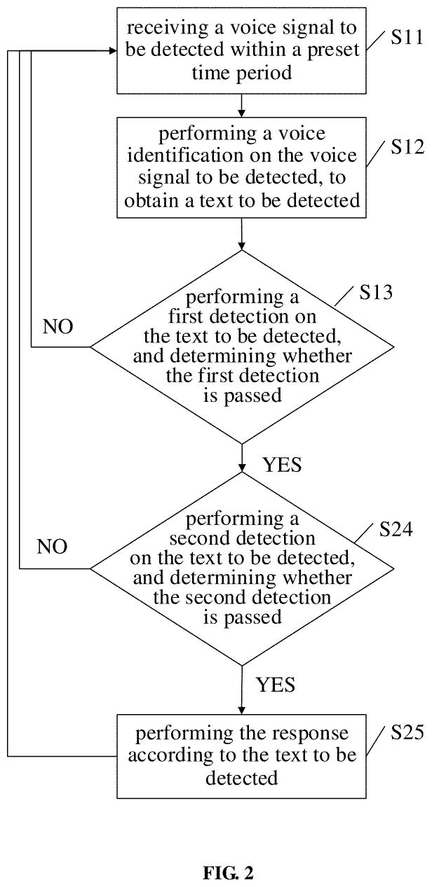

FIG. 2 is a flowchart showing a voice interaction method according to another embodiment of the present application. The method includes: receiving a voice signal to be detected within a preset time period at S11; performing a voice identification on the voice signal to be detected, to obtain a text to be detected at S12; performing a first detection on the text to be detected, and returning to S11 in response to determining that the first detection is not passed, or performing S24 in response to determining that the first detection is passed at S13; performing a second detection on the text to be detected in response to determining that the first detection is passed, returning to S11 in response to determining that the second detection is not passed, and performing S25 in response to determining that the second detection is passed at S24; performing the response according to the text to be detected, and returning to S11 at S25.

The embodiments of the present application may be applied to a voice interaction device. The voice interaction device may include various devices having a voice interaction function, including but not limited to a smart speaker, a smart speaker with a screen, a television with a voice interaction function, a smart watch, a story machine, and an onboard intelligent voice apparatus.

In an embodiment of the present application, after a voice interaction apparatus is woken up, the receiving a voice signal to be detected within a preset time period at S11 may be performed. That is to say, after the voice interaction apparatus receives the voice signal, the voice signal is taken as the voice to be detected. The voice interaction apparatus may perform two detections on the text to be detected corresponding to the voice to be detected to avoid misidentification. The two detections include a first detection and a second detection.

The performing a first detection on the text to be detected may include performing a grammar and/or semantic detection on the text to be detected, with a preset first detection model. For example, it is determined whether the text to be detected conforms to the grammatical and/or semantic characteristics of a voice instruction provided by a human to the voice interactive apparatus.

The performing a second detection on the text to be detected may include performing a contextual logic relation detection on the text to be detected, with a preset second detection model. For example, it is determined whether there is a contextual logic relation between the text to be detected and at least one previous voice interaction.

In a possible implementation, the voice interaction method further includes establishing the first detection model by training the first detection model by using a plurality of instruction texts and a plurality of non-instruction texts. The instruction texts are texts associated with voice instructions provided by a user to the voice interaction apparatus, which may be referred to as positive samples, and the non-instruction texts are texts associated with voice signals other than voice instructions, which may be referred to as negative samples. In the process of establishing the first detection model, the instruction texts or the non-instruction texts may be input into the first detection model. Then, it is predicted by the first detection model whether the received texts are positive samples, and it is determined whether the prediction result is consistent with actual situation. Parameters of the first detection model may be adjusted according to the determination results, thereby enabling prediction accuracy of the first detection model to meet a preset requirement.

When performing the first detection on the text to be detected, the text to be detected may be input into the first detection model. In case that the first detection model predicts that the text to be detected is an instruction text, it is determined that the detection is passed; in case that the first detection model predicts that the text to be detected is a non-instruction text, it is determined that the detection is not passed.

In a possible implementation, the voice interaction method further includes establishing the second detection model by training the second detection model with a plurality of sets of voice interactive texts and a plurality of sets of non-voice interactive texts.

The voice interaction texts may be referred to as positive samples, and each set of voice interaction texts may include texts associated with voice instructions in at least two rounds of voice interactions and responses to the texts, and a contextual logic relation exists between the at least two rounds of voice interactions.

For example, the texts and responses in the following voice interactions are positive samples:
User: How is the weather today?
Apparatus: The weather is fine today. The minimum temperature is 20 degrees and the maximum temperature is 27 degrees.
User: How about tomorrow?
Apparatus: There will be showers tomorrow, please bring an umbrella with you when going out.
User: How long will they last?
Apparatus: There are only a few showers around two o'clock in the afternoon and will not last long.

In the above voice interactions, three rounds of the voice interaction occur. Each round of voice interaction has a contextual logic relation with the previous round of voice interaction. In the second round of voice interaction, the voice instruction provided by the user is “How about Tomorrow?”, and the voice instruction has no precise meaning when it appears alone; however, in the case where the voice instruction is combined with the content of the previous round of voice interaction, it may be concluded that the voice instruction has the meaning “How is the weather tomorrow?”. Similarly, in the third round of voice interaction, the voice instruction provided by the user is “How long will they last?”, and the voice instruction also has no precise meaning when it appears alone; however, in the case where the voice instruction is combined with the content of the previous round of voice interaction, it may be concluded that the voice instruction has the meaning “How long will the showers of tomorrow last?”.

The non-voice interactive texts may be referred to as negative samples, and each set of the non-voice interactive texts includes texts associated with at least two voice instructions between which no contextual logic relation exists.

In the process of establishing the second detection model, the voice interaction texts or the non-voice interaction texts may be input into the second detection model which predicts whether the received texts are positive samples or not, and then it is determined whether the prediction result is consistent with actual situation. Parameters of the second detection model may be adjusted according to the determination results, thereby enabling prediction accuracy of the second detection model to meet a preset requirement.

In a possible implementation, when performing the second detection on the text to be detected, the text to be detected, a historical instruction text associated with a historical voice instruction of the text to be detected and a historical response to the historical instruction text are input into the second detection model. In case that the second detection model predicts that the text to be detected has a contextual logic relation with the historical instruction text and the historical response, it is determined that the second detection is passed; in case that the second detection model predicts that the text to be detected has no contextual logic relation with the historical instruction text and the historical response with the second detection model, it is determined that the second detection is not passed. The historical voice instruction may include at least one voice instruction preceding the voice to be detected.

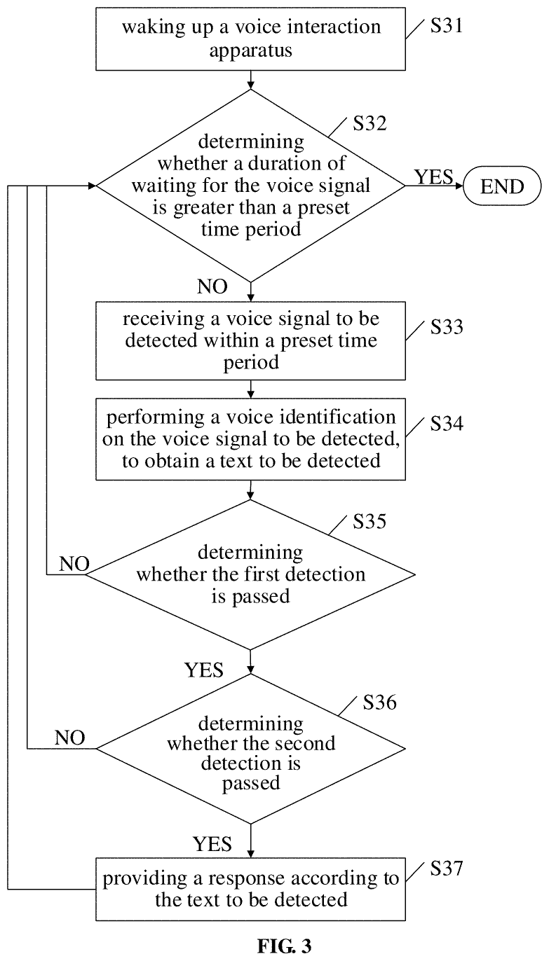

FIG. 3 is a flowchart showing a voice interaction process according to an embodiment of the present application.

The voice interaction process includes receiving a voice signal and performing a voice identification on the voice signal, to obtain text data associated with the voice signal; determining a wake-up word in the text data and waking up a voice interaction apparatus at S31.

The voice interaction process further includes determining whether a duration of waiting for the voice signal is greater than a pre-set time period at S32. In case that the duration of waiting for the voice signal is greater than the pre-set time period, the current process is ended. On the contrary, S33 is performed.

The voice interaction process further includes receiving a voice signal to be detected within a pre-set time period at S33. The voice signal to be detected may be sent by a user or may be sent by an apparatus with a sound playing function.

The voice interaction process further includes performing a voice identification on the voice signal to be detected, to obtain a text to be detected at S34.

The voice interaction process further includes performing a first detection on the text to be detected by using the preset first detection model and determining whether the first detection is passed at S35. When it is determined that the first detection is passed, S36 is performed. When it is determined that the first detection is not passed, the process returns to S32. When the first detection is performed, the text to be detected may be input into the first detection model, and in case that the first detection model predicts that the text to be detected is an instruction text, it is determined that the first detection is passed; in case that the first detection model predicts that the text to be detected is a non-instruction text, it is determined that the first detection is not passed.

The voice interaction process further includes performing a second detection on the text to be detected by using the preset second detection model and determining whether the second detection is passed at S36. When the second detection is passed, S37 is performed. When the second detection is not passed, the process returns to S32. When performing the second detection, the text to be detected, the historical instruction text in the previous at least one round of the voice interaction and the historical response may be input into the second detection model. In case that the second detection model predicts that the text to be detected has a contextual logic relation with the historical instruction text and the historical response, it is determined that the second detection is passed. In case that the second detection model predicts that the text to be detected has no contextual logic relation with the historical instruction text and the historical response, it is determined that the second detection is not passed.

The voice interaction process further includes providing a response according to the text to be detected at S37. Then, the process returns to S32.

If a detection criterion for the text corresponding to a voice instruction is too strict, the detection on the text may not be passed. In order to avoid the failure of passing the detection, so that the voice interaction apparatus does not respond to the voice instruction of the user, in a possible implementation, in the case where it is determined that the first detection is passed at S35, a response may be made according to the text to be detected. After that, the second detection can be further performed on the basis of combining various comprehensive factors, such as contextual logic relations, understanding and satisfaction of the user's needs by the voice interaction apparatus, and the like.

In addition, after S33 and before S34, the method may further include performing a detection on the voice signal to be detected according to at least one of a sound source, a signal-to-noise ratio, a sound intensity, and a voiceprint characteristic of the voice signal to be detected. In a case where the detection is passed, it is determined to further perform S34, otherwise, it is determined to turn back to S32. In a possible implementation, the voice signal to be detected may be evaluated by scoring the sound source, the signal-to-noise ratio, the sound intensity, and the voiceprint characteristic, respectively. Then, the individual scores are weighted and summed, to obtain a comprehensive score for the voice signal to be detected. In a case where the comprehensive score is larger than a preset score threshold, it is determined that the detection on the voice signal to be detected is passed; otherwise, it is determined that the detection on the voice signal to be detected is not passed.

The evaluating the voice signal to be detected by scoring the sound source may include: determining a distance between the sound source and the voice interaction apparatus, and determining an evaluation result of the voice signal to be detected with respect to the sound source according to a correspondence between a pre-stored distance and a corresponding pre-stored first score (i.e., according to correspondences between different distances and the corresponding scores). For example, when the distance between the sound source and the voice interaction apparatus is 0, it is indicated that the voice signal to be detected is sent by the voice interaction apparatus, the evaluation result of the voice signal to be detected with respect to the sound source is 0.

The evaluating the voice signal to be detected by scoring the signal-to-noise ratio may include: determining a signal-to-noise ratio of the voice signal to be detected, and determining an evaluation result of the voice signal to be detected with respect to the signal-to-noise ratio according to a correspondence between a pre-stored signal-to-noise ratio and a corresponding pre-stored second score (i.e., according to correspondences between different signal-to-noise ratios and the corresponding scores). For example, the larger the signal-to-noise ratio, the higher the evaluation result of the voice signal to be detected with respect to the signal-to-noise ratio.

The evaluating the voice signal to be detected by scoring the sound intensity may include: determining a sound intensity of the voice signal to be detected, and determining an evaluation result of the voice signal to be detected with respect to the sound intensity according to a correspondence between a pre-stored sound intensity and a corresponding pre-stored third score (i.e., according to correspondences between different sound intensities and the corresponding scores). For example, the lower the sound intensity, the lower the evaluation result of the voice signal to be detected with respect to the sound intensity.

The evaluating the voice signal to be detected by scoring the voice characteristic may include: determining a voice characteristic of the voice signal to be detected, comparing the voice characteristic of the voice signal to be detected with a voiceprint characteristic of a voice signal containing a wake-up word, to obtain a similarity, and determining an evaluation result of the voice signal to be detected with respect to the voiceprint characteristic according to the similarity. For example, in a case where the similarity is low, it is indicated that the voice signal to be detected and the voice signal containing the wake-up word are not provided by a same person, the evaluation result of the voice signal to be detected with respect to the voiceprint characteristic is 0.

After the evaluation of the voice signal to be detected with respect to the above factors, the individual scores may be weighted and summed, to obtain a comprehensive score for the voice signal to be detected. The weights used in the weighted summation calculation can be set according to preset rules or can be set by the user.

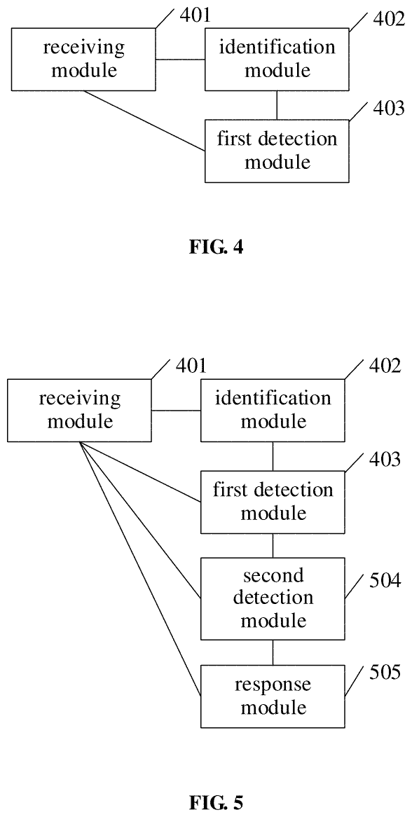

A voice interaction apparatus is further provided according to an embodiment of the present application. FIG. 4 is a schematic structural diagram showing a voice interaction apparatus according to an embodiment of the present application. As shown in FIG. 4, the apparatus includes: a receiving module 401 configured to receive a voice signal to be detected within a preset time period; an identification module 402 configured to perform a voice identification on the voice signal to be detected, to obtain a text to be detected; and a first detection module 403 configured to perform a first detection on the text to be detected, provide a response according to the text to be detected in response to determining that the first detection is passed, and instruct the receiving module 401 to perform another receiving in case that the first detection is not passed.

Another voice interaction apparatus is further provided according to an embodiment of the present application. FIG. 5 is a schematic structural diagram showing a voice interaction apparatus according to an embodiment of the present application. As shown in FIG. 5, the apparatus includes a receiving module 401 configured to receive a voice signal to be detected within a preset time period; an identification module 402 configured to perform a voice identification on the voice signal to be detected, to obtain a text to be detected; a first detection module 403 configured to perform a first detection on the text to be detected, provide a response according to the text to be detected in response to determining that the first detection is passed, and instruct the receiving module 401 to perform another receiving in case that the first detection is not passed; a second detection module 504 configured to perform a second detection on the text to be detected in response to determining that the first detection is passed; and a response module 505 configured to perform the response according to the text to be detected, in response to determining that the second detection is passed, and instruct the receiving module 401 to perform another receiving.

In a possible implementation, the second detection module 504 is further configured to instruct the receiving module 401 to perform another receiving in case that the second detection is not passed.

In a possible implementation, the first detection module 403 is further configured to perform a grammar and/or semantic detection on the text to be detected, with a preset first detection model, and the second detection module 504 is further configured to perform a contextual logic relation detection on the text to be detected, with a preset second detection model.

In a possible implementation, the first detection model is established by training the first detection model by using a plurality of instruction texts and a plurality of non-instruction texts, wherein the plurality of instruction texts are texts associated with voice instructions, and the plurality of non-instruction texts are texts associated with voice signals other than voice instructions.

In a possible implementation, the first detection module 403 is further configured to input the text to be detected into the first detection model, and predict that the text to be detected is an instruction text with the first detection model, and determine that the first detection is passed; or predict that the text to be detected is a non-instruction text with the first detection model, and determine that the first detection is not passed.

In a possible implementation, the second detection model is established by training the second detection model by using a plurality of sets of voice interactive texts and a plurality of sets of non-voice interactive texts, wherein each set of voice interactive texts includes texts associated with voice instructions in at least two rounds of voice interactions and responses to the texts, and a contextual logic relation exists between the at least two rounds of voice interactions, and each set of the non-voice interactive texts includes texts associated with at least two voice instructions between which no contextual logic relation exists.

In a possible implementation, the second detection module 504 is further configured to input the text to be detected, a historical instruction text associated with a historical voice instruction of the text to be detected and a historical response to the historical instruction text into the second detection model, and predict that the text to be detected has a contextual logic relation with the historical instruction text and the historical response with the second detection model, and determine that the second detection is passed; or predict that the text to be detected has no contextual logic relation with the historical instruction text and the historical response with the second detection model, and determine that the second detection is not passed.

In this embodiment, functions of modules in the apparatus refer to the corresponding description of the method mentioned above and thus a detailed description thereof is omitted herein.

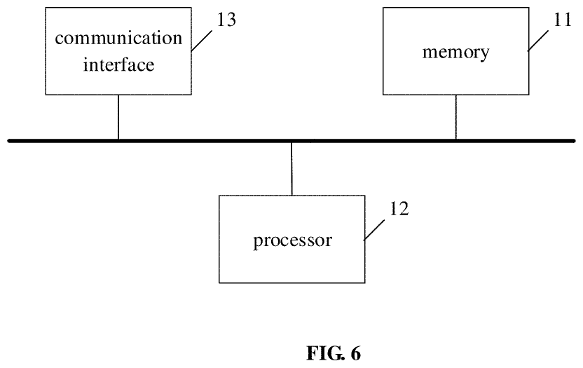

A voice interaction device is provided according to another embodiment of the present application. FIG. 6 is a schematic structural diagram showing a voice interaction device according to an embodiment of the present application. As shown in FIG. 6, the device includes a memory 11 and a processor 12, wherein a computer program that can run on the processor 12 is stored in the memory 11. The processor 12 executes the computer program to implement the voice interaction method according to the foregoing embodiments. The number of either the memory 11 or the processor 12 may be one or more.

The device may further include a communication interface 13 configured to communicate with an external device and exchange data.

The memory 11 may include a high-speed RAM memory and may also include a non-volatile memory, such as at least one magnetic disk memory.

If the memory 11, the processor 12, and the communication interface 13 are implemented independently, the memory 11, the processor 12, and the communication interface 13 may be connected to each other via a bus to realize mutual communication. The bus may be an Industry Standard Architecture (ISA) bus, a Peripheral Component Interconnected (PCI) bus, an Extended Industry Standard Architecture (EISA) bus, or the like. The bus may be categorized into an address bus, a data bus, a control bus, and the like. For ease of illustration, only one bold line is shown in FIG. 4 to represent the bus, but it does not mean that there is only one bus or one type of bus.

Optionally, in a specific implementation, if the memory 11, the processor 12, and the communication interface 13 are integrated on one chip, the memory 11, the processor 12, and the communication interface 13 may implement mutual communication through an internal interface.

In the description of the specification, the description of the terms “one embodiment,” “some embodiments,” “an example,” “a specific example,” or “some examples” and the like means the specific features, structures, materials, or characteristics described in connection with the embodiment or example are included in at least one embodiment or example of the present application. Furthermore, the specific features, structures, materials, or characteristics described may be combined in any suitable manner in any one or more of the embodiments or examples. In addition, different embodiments or examples described in this specification and features of different embodiments or examples may be incorporated and combined by those skilled in the art without mutual contradiction.

In addition, the terms “first” and “second” are used for descriptive purposes only and are not to be construed as indicating or implying relative importance or implicitly indicating the number of indicated technical features. Thus, features defining “first” and “second” may explicitly or implicitly include at least one of the features. In the description of the present application, “a plurality of” means two or more, unless expressly limited otherwise.

Any process or method descriptions described in flowcharts or otherwise herein may be understood as representing modules, segments or portions of code that include one or more executable instructions for implementing the steps of a particular logic function or process. The scope of the preferred embodiments of the present application includes additional implementations where the functions may not be performed in the order shown or discussed, including according to the functions involved, in substantially simultaneous or in reverse order, which should be understood by those skilled in the art to which the embodiment of the present application belongs.

Logic and/or steps, which are represented in the flowcharts or otherwise described herein, for example, may be thought of as a sequencing listing of executable instructions for implementing logic functions, which may be embodied in any computer-readable medium, for use by or in connection with an instruction execution system, device, or apparatus (such as a computer-based system, a processor-included system, or other system that fetch instructions from an instruction execution system, device, or apparatus and execute the instructions). For the purposes of this specification, a “computer-readable medium” may be any device that may contain, store, communicate, propagate, or transport the program for use by or in connection with the instruction execution system, device, or apparatus. The computer readable medium of the embodiments of the present application may be a computer readable signal medium or a computer readable storage medium or any combination of the above. More specific examples (not a non-exhaustive list) of the computer-readable media include the following: electrical connections (electronic devices) having one or more wires, a portable computer disk cartridge (magnetic device), random access memory (RAM), read only memory (ROM), erasable programmable read only memory (EPROM or flash memory), optical fiber devices, and portable read only memory (CDROM). In addition, the computer-readable medium may even be paper or other suitable medium upon which the program may be printed, as it may be read, for example, by optical scanning of the paper or other medium, followed by editing, interpretation or, where appropriate, process otherwise to electronically obtain the program, which is then stored in a computer memory.

It should be understood various portions of the present application may be implemented by hardware, software, firmware, or a combination thereof. In the above embodiments, multiple steps or methods may be implemented in software or firmware stored in memory and executed by a suitable instruction execution system. For example, if implemented in hardware, as in another embodiment, they may be implemented using any one or a combination of the following techniques well known in the art: discrete logic circuits having a logic gate circuit for implementing logic functions on data signals, application specific integrated circuits with suitable combinational logic gate circuits, programmable gate arrays (PGA), field programmable gate arrays (FPGAs), and the like.

Those skilled in the art may understand that all or some of the steps carried in the methods in the foregoing embodiments may be implemented by a program instructing relevant hardware. The program may be stored in a computer-readable storage medium, and when executed, one of the steps of the method embodiment or a combination thereof is included.

In addition, each of the functional units in the embodiments of the present application may be integrated in one processing module, or each of the units may exist alone physically, or two or more units may be integrated in one module. The above-mentioned integrated module may be implemented in the form of hardware or in the form of software functional module. When the integrated module is implemented in the form of a software functional module and is sold or used as an independent product, the integrated module may also be stored in a computer-readable storage medium. The storage medium may be a read only memory, a magnetic disk, an optical disk, or the like.

In summary, in the voice interaction method and apparatus according to embodiments of the present application, after a voice interaction apparatus is waken up, it is determined whether a time period of waiting for a voice signal input is larger than a preset time period. In a case where the time period of waiting for a voice signal input is larger than the pre-set time period, it is determined not to receive any voice signals. In a case where the time period of waiting for a voice signal input is not larger than the pre-set time period, it is determined to receive voice signals to be detected, and to perform a voice identification on the voice signal to be detected, in order to obtain a text to be detected. Then, the text to be detected can be detected twice. In a case where the detections are passed, a response is provided according to the text to be detected. In a case where the detections are not passed, no response according to the text to be detected is performed, the process turns back to the determining whether a time period of waiting for a voice signal input is larger than a preset time period. In this way, the misrecognition rate of a voice signal during a voice interaction is reduced, thereby improving user experience.

The foregoing descriptions are merely specific embodiments of the present application, but not intended to limit the protection scope of the present application. Those skilled in the art may easily conceive of various changes or modifications within the technical scope disclosed herein, all these should be covered within the protection scope of the present application. Therefore, the protection scope of the present application should be subject to the protection scope of the claims.

What is claimed is:

1. A voice interaction method, comprising:
receiving a voice signal to be detected within a preset time period;
performing a voice identification on the voice signal to be detected, to obtain a text to be detected; and
performing a first detection on the text to be detected, and providing a response according to the text to be detected in response to determining that the first detection is passed.

2. The voice interaction method according to claim 1, wherein the providing a response according to the text to be detected in response to determining that the first detection is passed comprises:
performing a second detection on the text to be detected in response to determining that the first detection is passed; and
performing the response according to the text to be detected, in response to determining that the second detection is passed.

3. The voice interaction method according to claim 2, wherein
the performing a first detection on the text to be detected comprises: performing a grammar and/or semantic detection on the text to be detected, with a preset first detection model; and
the performing a second detection on the text to be detected comprises: performing a contextual logic relation detection on the text to be detected, with a preset second detection model.

4. The voice interaction method according to claim 3, wherein the method further comprises establishing the first detection model by:
training the first detection model by using a plurality of instruction texts and a plurality of non-instruction texts; wherein
the plurality of instruction texts are texts associated with voice instructions, and the plurality of non-instruction texts are texts associated with voice signals other than voice instructions.

5. The voice interaction method according to claim 4, wherein the performing a first detection on the text to be detected comprises:
inputting the text to be detected into the first detection model; and
predicting that the text to be detected is an instruction text with the first detection model, and determining that the first detection is passed; or predicting that the text to be detected is a non-instruction text with the first detection model, and determining that the first detection is not passed.

6. The voice interaction method according to claim 3, wherein the method further comprises establishing the second detection model by:
training the second detection model by using a plurality of sets of voice interactive texts and a plurality of sets of non-voice interactive texts; wherein
each set of voice interactive texts comprises texts associated with voice instructions in at least two rounds of voice interactions and responses to the texts, and a contextual logic relation exists between the at least two rounds of voice interactions; and
each set of the non-voice interactive texts comprises texts associated with at least two voice instructions between which no contextual logic relation exists.

7. The voice interaction method according to claim 3, wherein the performing a second detection on the text to be detected comprises:
inputting the text to be detected, a historical instruction text associated with a historical voice instruction of the text to be detected and a historical response to the historical instruction text into the second detection model; and
predicting that the text to be detected has a contextual logic relation with the historical instruction text and the historical response with the second detection model, and determining that the second detection is passed; or predicting that the text to be detected has no contextual logic relation with the historical instruction text and the historical response with the second detection model, and determining that the second detection is not passed.

8. A voice interaction apparatus, comprising:
one or more processors; and
a memory for storing one or more programs, wherein
the one or more programs are executed by the one or more processors to enable the one or more processors to:
receive a voice signal to be detected within a preset time period;
perform a voice identification on the voice signal to be detected, to obtain a text to be detected; and
perform a first detection on the text to be detected, and provide a response according to the text to be detected in response to determining that the first detection is passed.

9. The voice interaction apparatus according to claim 8, wherein the one or more programs are executed by the one or more processors to enable the one or more processors to:
perform a second detection on the text to be detected in response to determining that the first detection is passed; and
perform the response according to the text to be detected, in response to determining that the second detection is passed.

10. The voice interaction apparatus according to claim 9, wherein the one or more programs are executed by the one or more processors to enable the one or more processors to:
perform a grammar and/or semantic detection on the text to be detected, with a preset first detection model; and
perform a contextual logic relation detection on the text to be detected, with a preset second detection model.

11. The voice interaction apparatus according to claim 10, wherein the one or more programs are executed by the one or more processors to enable the one or more processors to establish the first detection model by:
training the first detection model by using a plurality of instruction texts and a plurality of non-instruction texts; wherein
the plurality of instruction texts are texts associated with voice instructions, and the plurality of non-instruction texts are texts associated with voice signals other than voice instructions.

12. The voice interaction apparatus according to claim 11, wherein the one or more programs are executed by the one or more processors to enable the one or more processors to
input the text to be detected into the first detection model; and
predict that the text to be detected is an instruction text with the first detection model, and determine that the first detection is passed; or predict that the text to be detected is a non-instruction text with the first detection model, and determine that the first detection is not passed.

13. The voice interaction apparatus according to claim 10, wherein the one or more programs are executed by the one or more processors to enable the one or more processors to establish the second detection model by:
training the second detection model by using a plurality of sets of voice interactive texts and a plurality of sets of non-voice interactive texts; wherein
each set of voice interactive texts comprises texts associated with voice instructions in at least two rounds of voice interactions and responses to the texts, and a contextual logic relation exists between the at least two rounds of voice interactions; and
each set of the non-voice interactive texts comprises texts associated with at least two voice instructions between which no contextual logic relation exists.

14. The voice interaction apparatus according to claim 10, wherein the one or more programs are executed by the one or more processors to enable the one or more processors to:
input the text to be detected, a historical instruction text associated with a historical voice instruction of the text to be detected and a historical response to the historical instruction text into the second detection model; and
predict that the text to be detected has a contextual logic relation with the historical instruction text and the historical response with the second detection model, and determine that the second detection is passed; or predict that the text to be detected has no contextual logic relation with the historical instruction text and the historical response with the second detection model, and determine that the second detection is not passed.

15. A non-transitory computer-readable storage medium, in which a computer program is stored, wherein the computer program, when executed by a processor, causes the processor to implement the method of claim 1.
